(19) United States
(12) Patent Application Publication
(10) Pub. No.: US 2025/0227665 A1
(43) Pub. Date: Jul. 10, 2025

(54) DYNAMIC NETWORK SLICING

(71) Applicant: T-Mobile Innovations LLC, Overland Park, KS (US)

(72) Inventor: Gunjan NIMBAVIKAR, Sammamish, WA (US)

(21) Appl. No.: 18/404,660

(22) Filed: Jan. 4, 2024

(51) Int. Cl. H04W 72/04; H04W 28/02

(52) U.S. Cl. CPC H04W 72/04; H04W 28/0268

(57) ABSTRACT

Methods, systems, and a non-transitory computer-readable medium that provide methods, systems, and computer-readable media that dynamically allocating network resources to devices in a network are provided. The method begins with determining an allocation of network resources to a user device accessing a service. The determining may be based on an anticipated quality of service (QoS) for the service. The anticipated QoS may be based on a user using the full capabilities of the service. The method then continues with dynamically re-allocating the allocation of network resources based on an actual use of the network resources for the service. The dynamic re-allocation of network resources may be based on an uplink message from the UE, wherein the uplink message contains information about the network resources being used for the call.

### SUMMARY

The present disclosure is directed to dynamic network slicing, substantially as shown and/or described in connection with at least one of the Figures, and as set forth more completely in the claims

According to various aspects of the technology, dynamic network slicing is utilized to enable and disable a dedicated slice for a user. In some instances, a user equipment (UE) may be assigned to a particular network slice in order to effectuate a certain allocation of network resources to the UE, such as when the UE is accessing or utilizing a particular application or service. The network slice may be based on a minimum quality of service (QoS) needed for the UE to effectively access or use said application or service. Selection and assignment of a network slice to the UE may be based on typical UE actions, but not necessarily what the UE has actually requested; for example, a UE may be assigned a particular network slice when the UE uses a video calling application (e.g., Zoom® or Webex®). In aspects of the present disclosure, the UE may be allocated network resources differently than the network slice directs based on actual UE behavior.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts dynamic network slicing in a network, in which implementations of the present disclosure may be employed, in accordance with aspects herein;

FIG. 3 is a flow diagram of a method for dynamically allocating network resources to devices in a network, in accordance with aspects herein; and

FIG. 4 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, network slicing is an architectural paradigm in telecommunication networks wherein a network resources are logically partitioned into multiple virtual networks, or “slices,” each catering to distinct service requirements. Network slicing allows for the allocation and isolation of resources such as computing, storage, and bandwidth and can be customized with specific Quality of Service (QoS) characteristics, latency profiles, and security parameters to meet the unique demands of diverse applications, services, or user groups. Using network slicing, mobile network operators can efficiently share a common network infrastructure while accommodating the different needs of services including ultra-reliable low-latency communication (URLLC) and enhanced mobile broadband (eMBB).

Conventionally, network slicing assumes that an application or service always needs a dedicated slice that is statically assigned. In this static assignment, the dedicated slice always receives the quality of service (QoS), even if that QoS is not needed for the particular use case. One example is that of a conferencing application that allows use of video calling features and also audio features, where some meetings are video meetings that use the full range of services. Other meetings may use only the audio services, however, the dedicated slice with full video capability is still assigned. That is conventional static approaches to network slicing may lead to unused network resources being allocated to user devices. During times with low congestion, this inefficient utilization of limited network resources may be without consequence; however, particularly during congestion, unused static network slicing can lead to unnecessary service degradation.

Unlike conventional solutions, the present disclosure is directed to a dynamic network slicing paradigm. In some aspects, network slice resources may be allocated to a user device based on actual usage or behavior from the UE-instead of associating network slicing decisions on a subscriber or application profile. In other aspects, the dynamic network slicing described herein may be premised or triggered by a threshold high congestion or utilization by a network. By dynamically granting a user device access to network slices, a telecommunication network can more efficiently utilize limited network resources, and in some aspects, the dynamic allocation of network slicing resources may not be discernable to a particular user.

As used herein, “access point” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE). The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby access point.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby access point or access point.

In aspects, a UE provides UE data including location and channel quality information to the wireless communication network via the access point. Location information may be based on a current or last known position utilizing GPS or other satellite location services, terrestrial triangulation, an access point's physical location, or any other means of obtaining coarse or fine location information. Channel quality information may indicate a realized uplink and/or downlink transmission data rate, observed signal-to-interference-plus-noise ratio (SINR), reference signal received quality (RSRQ), and/or signal strength at the user device, or throughput of the connection. Channel quality information may be provided via, for example, an uplink pilot time slot, downlink pilot time slot, sounding reference signal, channel quality indicator (CQI), rank indicator, precoding matrix indicator, or some combination thereof. Channel quality information may be determined to be satisfactory or unsatisfactory, for example, based on exceeding or being less than a threshold. Location and channel quality information may take into account the user device capability, such as the number of antennas and the type of receiver used for detection. Processing of location and channel quality information may be done locally, at the access point or at the individual antenna array of the access point. In other aspects, the processing of said information may be done remotely.

The UE data may be collected at predetermined time intervals measured in milliseconds, seconds, minutes, hours, or days. Alternatively, the UE data may be collected continuously. The UE data may be stored at a storage device of the UE, and may be retrievable by the UE's primary provider as needed and/or the UE data may be stored in a cloud based storage database and may be retrievable by the UE's primary provider as needed. When the UE data is stored in the cloud based storage database, the data may be stored in association with a data identifier mapping the UE data back to the UE, or alternatively, the UE data may be collected without an identifier for anonymity.

A first aspect of the present disclosure provides method for dynamically allocating network resources to devices in a network. The method comprises receiving a request from a user equipment (UE) to access a service. The method further comprises receiving a request from a user equipment (UE) to access a service. The method further comprises determining that a network slicing modification trigger has occurred. The method further comprises based on said determination, modifying the network slice assignment by allocating a second allocation of network resources to the UE, the second allocation of network resources being less than the first allocation of network resources.

A second aspect of the present disclosure provides a system for dynamically allocating network resources to devices in a network. The system comprises a radio access network node configured to wirelessly communicate with each of a first user equipment (UE) and a second UE. The system further comprises one or more computer processing components configured to perform operations. The operations comprise receiving a first request from the first UE for access to a first network slice associated with a service. The operations further comprise receiving a second request from the second UE for access to the first network slice associated with the service. The operations further comprise determining that a network slicing modification trigger has occurred. The operations further comprise based on said determination and a determination that the second UE is utilizing a first sub-service of the service and is not utilizing a second sub-service of the service, granting access to the first network slice for the first UE and granting access to a second network slice for the second UE.

Another aspect of the present disclosure is directed to a non-transitory computer storage media storing computer-usable instructions that cause the processors to receive a request from a user equipment (UE) to access a service, the service associated with a first network slice having a first allocation of network resources. The processor are further caused to determine that a congestion level of a radio access network node exceeds a predetermined threshold, the radio access network node having received the request. The processors are further caused to based on said determination, at least partially fulfilling the request using a second network slice, the second network slice having a second allocation of network resources, wherein the second allocation of network resources is less than the first allocation of network resources.

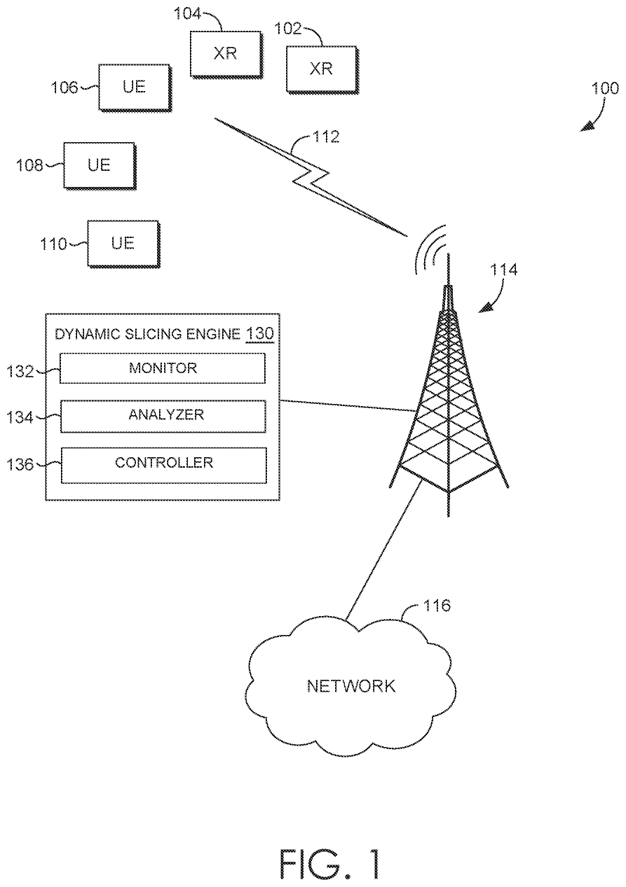

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

Network environment 100 includes user devices (UE) 102, 104, 106, 108, and 110, radio access network node 114 (which may be a cell site, access point, or the like), and one or more communication channels 112. The communication channels 112 can communicate over a frequency band assigned to the carrier. In network environment 100, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 500) that communicates via wireless communications with the radio access network node 114 in order to interact with a public or private network.

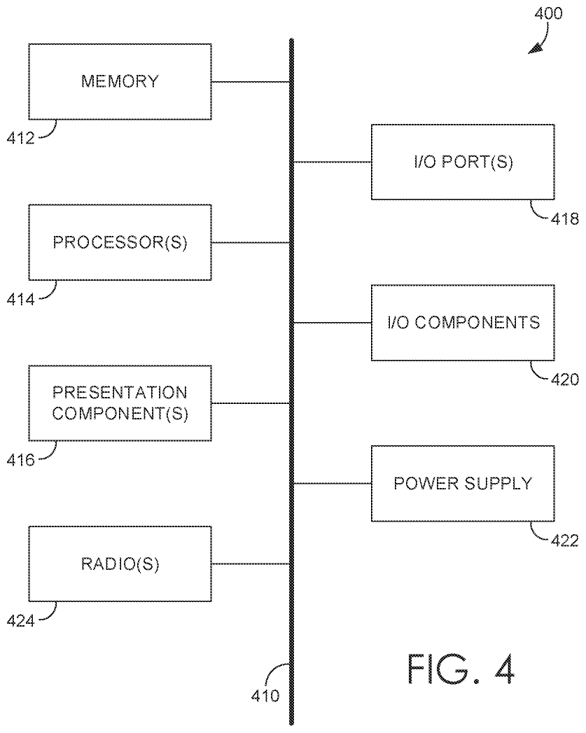

In some aspects, each of the UEs 102, 104, 106, 108, and 110 may correspond to computing device 400 in FIG. 4. Thus, a UE can include, for example, a display(s), a power source(s) (e.g., a battery), a data store(s), a speaker(s), memory, a buffer(s), a radio(s) and the like. In some implementations, for example, a UEs 102, 104, 106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, 6G, LTE, CDMA, or any other type of network. In some cases, UEs 102, 104, 106, 108, and 110 in network environment 100 can optionally utilize communication channels 112 to communicate with other computing devices (e.g., a mobile device(s), a server(s), a personal computer(s), etc.) through the radio access network node 114.

The network environment 100 may be comprised of a telecommunications network(s), or a portion thereof. A telecommunications network might include an array of devices or components (e.g., one or more access points), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

In some implementations, radio access network node 114 is configured to communicate with a UE, such as UEs 102, 104, 106, 108, and 110, that are located within the geographic area, or cell, covered by radio antennas of radio access network node 114. Radio access network node 114 may include one or more access points, base transmitter stations, radios, antennas, antenna arrays, power amplifiers, transmitters/receivers, digital signal processors, control electronics, GPS equipment, and the like. The radio access network node 114 is communicatively coupled to the dynamic slicing engine 130 and the network 116. The network 116 may represent all or a portion of a telecommunication network and/or data network, and is generally illustrated for the purpose that requests from one or more UEs 102, 104, 106, 108, and 110 may be at least partially fulfilled or responded to by one or more destinations or components of the network 116.

The dynamic slicing engine 130 is generally performed to make and carry out dynamic slicing decisions according to one or more aspects of the present disclosure. Network slicing is a type of network functionality that logically defines one or more network resources in order to provide a certain quality of service (QOS) or make available a certain amount of network resources for certain types of devices or activities. Each slice of traffic may have its own resource requirements, QoS, security configuration, and latency requirements. For example, a network slice supporting high definition streaming video has different requirements from a network slice monitoring a simple Internet of Things (IoT) device, such as a motion detector. The dynamic slicing engine 130 may be said to comprise a monitor 132, an analyzer 134, and a controller 136.

The monitor 132 is generally configured to monitor requests from the one or more user devices that are requesting network resources via the radio access network node 114. The monitor 132 is configured to process requests received by the radio access network node 114 to determine that the requests are associated with a first network slice. For example, if a mobile network operator has assigned a first network slice for video conferencing, the monitor 132 may process a request from UE 106 for video conferencing and determine that said request is to be processed using the first network slice. Similarly, the monitor 132 may receive a request from an XR device such as UE 102 and determine that said request is to be processed using a second network slice (e.g., specifically configured for XR devices needing low latency). The monitor 132 may also be configured to monitor the congestion of the radio access network node 114. In such an aspect the monitor 132 could determine congestion based on physical resource block (PRB) utilization, number of user devices connected to the radio access network node 114, or any other metric desirable by a mobile network operator.

The analyzer 134 is generally configured to determine the utilization of the radio access network node 114 and various network slices. In a first aspect, the analyzer 134 may be configured to inspect a UE's behavior to determine if the UE is fully utilizing a network slice; for example, whereas the monitor 132 may determine that the UE is using a video conferencing application, the analyzer 134 may determine that said UE is only utilizing one sub-service of the video conferencing application and is not using a second sub-service. In such an example, even though the UE is using a video conferencing application, the analyzer 134 may determine that only the audio stream is being used (and that the video portion is not being used/requested by the UE). In another aspect, the analyzer 134 may also be configured to determine if the congestion at the radio access node 114 exceeds a predetermined threshold. Exceeding the predetermined threshold may be on the basis of threshold PRB utilization, threshold high number of connected devices, or any other threshold desired by the mobile network operator.

The controller 136 is generally configured to determine that a network slicing modification trigger has occurred and to determine and cause a modification to a network slicing allocation. The network slicing modification trigger may be said to be the cause of the controller 136 making a modification to a network slicing allocation. In a first aspect, the network slicing modification trigger may comprise a determination that a congestion threshold has been exceeded at the radio access network node 114. In such an aspect, the controller 136 may either modify the network slicing assignment for all UEs connected to the radio access network node 114 by assigning a network slice that uses fewer network resources than that which was requested by the UEs. In another aspect, the controller 136 may modify the network slicing assignment for UEs that are not fully utilizing their requested network slice (e.g., a UE that is only using an audio sub-service of a video conferencing service and not a video sub-service). In yet other aspects, the network slicing modification trigger may be underutilization alone (i.e., without congestion). In such an aspect, the controller 136 may effectuate a change to a UE's network slice access based on the UE underutilizing that slice (e.g., only using the audio portion of a video conferencing service). In any aspect, the controller may modify the network slice assignment/access of the UE by scaling back the UE's allocated network slicing resources or by assigning the UE to a network slice that uses fewer network resources or has a reduced QOS compared to the default network slice associated with the UE's original request.

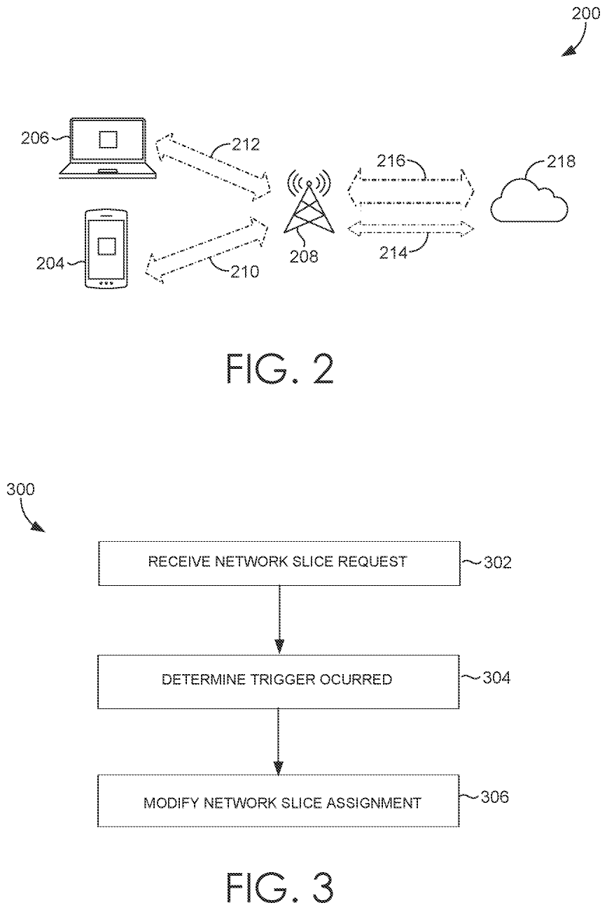

FIG. 2 depicts dynamic network slicing in a network, in which implementations of the present disclosure may be employed, in accordance with aspects herein. In a network 200, multiple devices may make similar requests to connect with a network. In accordance with one or more aspects described with respect to FIG. 1, a first UE 204 requests access to a network service 218 from a radio access network node 208, via connection 210, and a second UE 206 requests access to the network service 218 from the radio access network node 208 via connection 212. Because the first UE 204 and the second UE 206 are requesting access to the same network service 218 (e.g., a video conferencing server), each should be assigned a first network slice 216; however, based on a determination that a network slicing modification trigger has occurred (e.g., threshold high congestion at the radio access network node 208 or any other aspect described with respect to FIG. 1), one or more of the first UE 204 and the second UE 206 may be assigned a second network slice 214, wherein the second network slice 214 has fewer network resources or a lower QOS than the first network slice 216. For example, the first UE 204 may be assigned the second network slice 214 based on a determination that the first UE 204 is only using a portion of the requested network service 218. In other examples, actual use by the UE may not be factored, and both the first UE 204 and the second UE 206 may be assigned the second network slice 214 instead of the first network slice 216 regardless of their individual utilization.

FIG. 3 is a flow diagram of a method for dynamically allocating network resources to devices in a network, in accordance with aspects herein. The method 400 comprises a first step 302 wherein a request is received from a UE to access a service, according to any one or more aspects described with respect to FIGS. 1-2. The method 300 further comprises a second step 304 wherein it is determined that a network slicing modification trigger has occurred, according to any one or more aspects described with respect to FIGS. 1-2. The method 300 further comprises a third step 306 wherein network slicing assignments are modified according to any one or more aspects described with respect to FIGS. 1-2.

FIG. 4 depicts an exemplary computing device suitable for use in implementations of the present disclosure, in accordance with aspects herein. With continued reference to FIG. 4, computing device 400 includes bus 410 that directly or indirectly couples the following devices: memory 412, one or more processors 414, one or more presentation components 416, input/output (I/O) ports 418, I/O components 420, radio(s) 424, and power supply 422. Bus 410 represents what may be one or more busses (such as an address bus, data bus, or combination thereof). Although the devices of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 4 and refer to “computer” or “computing device.”

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 400 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 412 includes computer-storage media in the form of volatile and/or nonvolatile memory. Memory 412 may be removable, nonremovable, or a combination thereof. Exemplary memory includes solid-state memory, hard drives, optical-disc drives, etc. Computing device 400 includes one or more processors 406 that read data from various entities such as bus 410, memory 412 or I/O components 420. One or more presentation components 416 present data indications to a person or other device. Exemplary one or more presentation components 416 include a display device, speaker, printing component, vibrating component, etc. I/O ports 418 allow computing device 400 to be logically coupled to other devices including I/O components 420, some of which may be built into computing device 400. Illustrative I/O components 420 include a microphone, joystick, game pad, satellite dish, scanner, printer, wireless device, etc.

The radio(s) 424 represents one or more radios that facilitate communication with a wireless telecommunications network. While a single radio 424 is shown in FIG. 4, it is contemplated that there may be more than one radio 424 coupled to the bus 410. Illustrative wireless telecommunications technologies include CDMA, GPRS, TDMA, GSM, and the like. The radio 424 may additionally or alternatively facilitate other types of wireless communications including Wi-Fi, WiMAX, LTE, 3G, 4G, LTE, 5G, NR, VOLTE, or other VOIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a access point, a communications tower, or even access points (as well as other components) can provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A method for dynamically allocating network resources to devices in a network, the method comprising:
receiving a request from a user equipment (UE) to access a service;
assigning a network slice to the UE for fulfilling the request for the service, the network slice having a first allocation of network resources to provide a target quality of service (QoS) for the service;
determining that a network slicing modification trigger has occurred; and
based on said determination, modifying the network slice assignment by allocating a second allocation of network resources to the UE, the second allocation of network resources being less than the first allocation of network resources.

2. The method of claim 1, wherein the service comprises at least a first sub-service and a second sub-service.

3. The method of claim 2, wherein the network slicing modification trigger comprises determining that the UE is utilizing the second sub-service and not the first sub-service.

4. The method of claim 3, wherein the first sub-service is associated with a first QOS and the second sub-service is associated with a second QOS, the first QOS being different than the second QOS.

5. The method of claim 4, wherein the service comprises a video conference, the first sub-service comprises a video stream, and the second sub-service comprises an audio stream.

6. The method of claim 3, wherein the network slicing modification trigger further comprises determining that a congestion level of a base station exceeds a predetermined threshold, the request from the UE to access the service being wireless transmitted to the base station.

7. The method of claim 6, wherein the predetermined threshold comprises a physical resource block (PRB) utilization.

8. A system for dynamically allocating network resources to devices in a network, the system comprising:
a radio access network node configured to wirelessly communicate with each of a first user equipment (UE) and a second UE;
one or more computer processing components configured to perform operations comprising:
receiving a first request from the first UE for access to a first network slice associated with a service;
receiving a second request from the second UE for access to the first network slice associated with the service;
determining that a network slicing modification trigger has occurred; and
based on said determination and a determination that the second UE is utilizing a first sub-service of the service and is not utilizing a second sub-service of the service, granting access to the first network slice for the first UE and granting access to a second network slice for the second UE.

9. The system of claim 8, wherein the network slicing modification trigger comprises determining that a congestion level of the radio access network node exceeds a predetermined threshold, and wherein each of the first request and second request are received by the radio access network node.

10. The system of claim 9, wherein the predetermined threshold comprises a physical resource block (PRB) utilization.

11. The system of claim 9, wherein the predetermined threshold comprises a number of users connected to the radio access network node.

12. The system of claim 10, wherein the first network slice is associated with a first quality of service (QOS) and the second network slice is associated with a second QOS, the second QOS requiring fewer network resources than the first QOS.

13. The system of claim 12, wherein the service is associated with video conferencing, the first sub-service comprises an audio component of the video conferencing and the second sub-service comprises a video component of the video conferencing.

14. A non-transitory computer readable media with instructions stored thereon that, when executed by one or more computer processing components, cause the one or more computer processing components to perform a method comprising:
receiving a request from a user equipment (UE) to access a service, the service associated with a first network slice having a first allocation of network resources;
determining that a congestion level of a radio access network node exceeds a predetermined threshold, the radio access network node having received the request; and
based on said determination, at least partially fulfilling the request using a second network slice, the second network slice having a second allocation of network resources, wherein the second allocation of network resources is less than the first allocation of network resources.

15. The non-transitory computer readable media of claim 14, wherein the predetermined threshold comprises a physical resource block (PRB) utilization.

16. The non-transitory computer readable media of claim 14, wherein the predetermined threshold comprises a number of users connected to the radio access network node.

17. The non-transitory computer readable media of claim 14, wherein the service comprises a plurality of sub-services.

18. The non-transitory computer readable media of claim 17, wherein at least partially fulfilling the request using the second network slice comprises granting access to the second sub-service and not to the first sub-service.

19. The non-transitory computer readable media of claim 18, wherein the service is associated with video conferencing, the first sub-service comprises a video component of the video conferencing and the second sub-service comprises an audio component of the video conferencing.

20. The non-transitory computer readable media of claim 19, wherein the method further comprises causing a notification to be displayed by the UE that a network service modification has been implemented.
